(19) United States
(12) Patent Application Publication
(10) Pub. No.: US 2006/0233413 A1
(43) Pub. Date: Oct. 19, 2006

(54) Automatic control earphone system using capacitance sensor

(76) Inventor: Seong-Hyun Nam, Seoul (KR)

Correspondence Address: JACKSON WALKER LLP, 901 MAIN STREET, SUITE 6000, DALLAS, TX, 75202-3797, US

(21) Appl. No.: 11/389,977

(22) Filed: Mar. 27, 2006

(30) Foreign Application Priority Data
Mar. 25, 2005 (KR) 10-2005-0024814

(51) Int. Cl. H04R 25/00

(52) U.S. Cl. 381/380

(57) ABSTRACT

Disclosed herein is an earphone system, including a device, such as an audio device, and at least one earpiece connected to the device. The automatic control earphone system of the present invention includes capacitance sensing means, a removal sensing unit, and a signal generation unit. The capacitance sensing means senses variation in capacitance generated with a human body. The removal sensing unit determines whether the earpiece has been inserted into or removed from the user's ear using the variation in capacitance sensed by the capacitance sensor. The signal generation unit generates one selected from an operation signal and a stop signal for the device depending on sensing results of the removal sensing unit, and outputs the generated signal to the device. According to the present invention, the on/off function of the device is automatically controlled through contact or non-contact of the earpiece with a human body.

### BACKGROUND OF THE INVENTION

1. Field of the Invention

The present invention relates, in general, to earphone systems and, more particularly, to an earphone system, which can automatically control the function of an audio device or another device by sensing the removal of an earpiece.

2. Description of the Related Art

Typically, an earphone is electrically connected to a device, such as an audio device or a mobile communication terminal, and is used thereby, and functions to convert sound sources provided by the device into user-recognizable sound and to output the sound. Meanwhile, the on/off function of such a device (in the case of a mobile communication terminal, a talk mode/standby mode) is performed through the manipulation of a button or switch provided on the device. In a more advanced form, there is a structure in which a control switch is provided on an earphone or earphone cable, but, even in this case, manipulation by a user is required.

As described above, the conventional earphone system is inconvenient because a user must personally manipulate an on/off (or a talk mode/standby mode) switch. According to the circumstances, there may occur a situation in which a device cannot be switched off after an earphone has been disconnected from the device, or in which the device is left as it is in a switched-on state for a long period of time.

### SUMMARY OF THE INVENTION

Accordingly, the present invention has been made keeping in mind the above problems occurring in the prior art, and an object of the present invention is to provide an earphone system, which can automatically control the function of an audio device or another device by sensing the removal of an earphone, so that separate manipulation by a user is not required.

In order to accomplish the above object, the present invention provides an automatic control earphone system using a capacitance sensor, the earphone system including one device, selected from among an audio device and a mobile communication terminal, and at least one earpiece electrically connected to the device. The earphone system comprises capacitance sensing means for sensing variation in capacitance generated with a human body; a removal sensing unit for determining whether the earpiece has been inserted into or removed from the user's ear using the variation in capacitance sensed by the capacitance sensor; and a signal generation unit for generating one selected from an operation signal and a stop signal for the device depending on sensing results of the removal sensing unit, and outputting the generated signal to the device.

According to the present invention, the on/off function of the device is automatically controlled by the contact or non-contact of an earpiece. Therefore, a user does not need to conduct a separate action to achieve such an on/off function. Accordingly, the problems of the conventional earphone system can be sufficiently solved by the present invention.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of an earphone system according to the present invention;

FIG. 2 is an exploded perspective view showing an embodiment of an earpiece applied to the present invention;

FIG. 3 is a perspective view showing another embodiment of the earpiece applied to the present invention;

FIG. 4 is a flow diagram showing signal processing in the earphone system according to the present invention; and

FIG. 5 is a flowchart showing the operational status of the earphone system according to the present invention.

### DESCRIPTION OF THE PREFERRED EMBODIMENTS

Hereinafter, embodiments of the present invention will be described in detail with reference to the attached drawings.

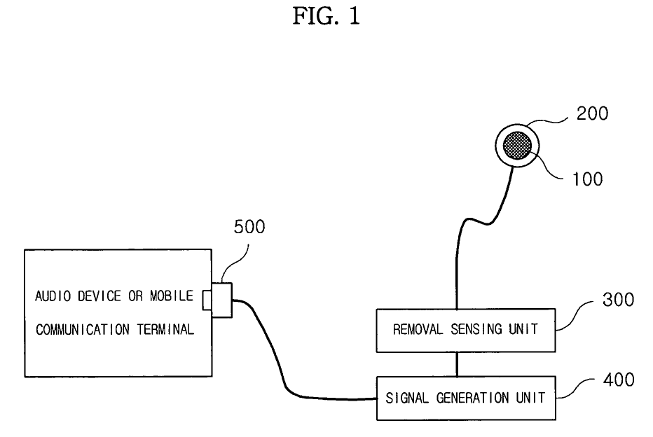

Referring to FIG. 1, an earphone system according to the present invention includes a capacitance sensor 200 installed on an earpiece 100, a removal sensing unit 300 for detecting a sensing signal output from the capacitance sensor 200 and determining whether the earpiece 100 has been inserted into or removed from the ear of a user for a predetermined period of time or longer, a signal generation unit 400 for generating a control signal required to control the on/off status of an audio device or another device (in the case of a mobile communication terminal, a talk mode/standby mode), based on the results of determination of the removal sensing unit 300, and an earphone plug 500 capable of being electrically connected to the audio device or to the mobile communication terminal.

In this case, both the removal sensing unit 300 and the signal generation unit 400 may be placed at about the middle of a cable for connecting the earpiece 100 with the plug 500, may be mounted in the earpiece 100, or may be mounted in the audio device or the mobile communication terminal.

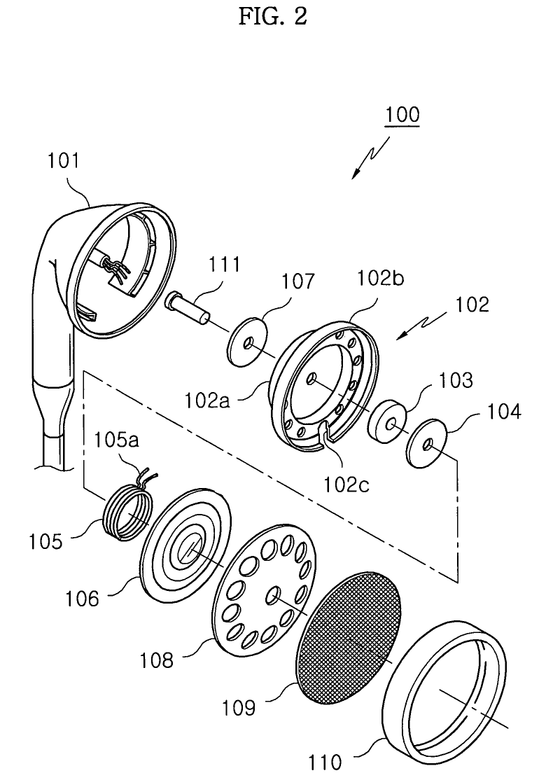

First, the construction of the earpiece shown in FIG. 2 is described below. The earpiece 100 applied to the present invention is a support type, and includes a housing 101, a yoke 102, a permanent magnet 103, a top plate 104, a voice coil 105, a diaphragm 106, a circuit board 107, a protective cover 108, a protective grille 109 and a finishing band 110. In this case, the yoke 102, the permanent magnet 103, the top plate 104 and the circuit board 107 are fixedly fastened to each other by a rivet 111.

Further, each of the finishing band 110, the protective grille 109 and the protective cover 108 is made of a conductive material (for example, conductive rubber, conductive silicon, conductive polyvinyl chloride [PVC], etc.). That is, of three lines drawn from the housing 101 (signal, ground and sensing lines), the signal and ground lines are required to be supplied with sound signals by the audio device or the mobile communication terminal. The remaining sensing line extends from the removal sensing unit 300, and is drawn from the housing 101 and directly connected to the conductive yoke 102, thus transmitting a signal corresponding to variation in capacitance. Therefore, the conductive yoke 102 is directly connected to the conductive protective cover 108, the conductive protective grille 109, and the conductive finishing band 110. In this case, the yoke 102, the finishing band 110, the protective grille 109 and the protective cover 108 can be fixedly fastened to each other by the rivet 111, and can thus be electrically connected to each other through the rivet 111.

Further, the yoke 102 includes a cylindrical part 102a for supporting the permanent magnet 103, and a flange part 102b for supporting the diaphragm 106. In a portion of the flange part 102b, a passing hole 102c is formed to pass a lead 105a of a voice coil 105 to allow connection of the lead 105a with the circuit board 107.

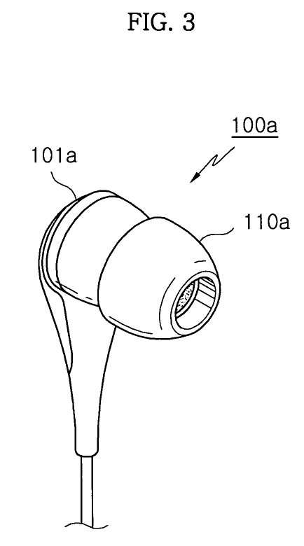

Referring to FIG. 3, an earpiece 100a is an insertion type, and is implemented so that an insertion type-rubber band (silicon band) is inserted into an ear, unlike the support type-earpiece 100 of FIG. 2. The insertion type-earpiece 100a is implemented such that an earphone housing 101a is made of a conductive material, such as conductive plastic, and a sensing line is electrically connected both to the conductive housing 101a and to a conductive band 110a through a conductive yoke (not shown).

Meanwhile, the typical operating process of the earpiece 100 or 100a is described in brief. The voice coil 105 is excited by a sound (current) signal. At this time, the voice coil 105 is interlinked with the magnetic flux of the permanent magnet 103 that exists between the yoke 102 and the top plate 104, and vertically vibrates depending on the intensity and frequency of the sound signal. Then, the diaphragm 106 coupled to the voice coil 105 vibrates together with the voice coil 105 to generate sound waves in the air, so that the voice signal is reproduced.

Meanwhile, the capacitance sensor applied to the present invention may be implemented using a single sensing line and a conductive sensing pad, and may be operated so that, if a human body comes into contact with the sensing pad, the human body generates capacitance between the sensing pad and the ground. Variation in the capacitance formed in this way is sensed by the removal sensing unit 300, so that whether the sensing pad is in contact with a human body is determined.

That is, when the user inserts the earpiece 100 or 100a into his or her ear, the part of the earpiece 100 or 100a that comes into broad contact with the human body is the finishing band 110 or 110a. Therefore, the finishing band 110 or 110a must be implemented using conductive material (rubber, silicon, PVC, etc.). The sensing line extending from the removal sensing unit is electrically connected to the conductive finishing band 110 or 110a through the conductive yoke 102, the conductive protective cover 108, and the conductive protective grille 109. In this case, the finishing band 110 or 110a functions as the capacitance sensor 200.

Further, the sensing line plays an important part in transmitting a signal, sensed by the finishing band 110 or 110a and indicating whether a human body is into contact with the finishing band, to the removal sensing unit 300. On the sensing line, parasitic capacitance may be generated by interference with an adjacent signal line, so a malfunction may occur. Therefore, the sensing line is preferably coated with enamel so as to minimize the influence of the external environment, and the external part of the enamel-coated sensing line is preferably surrounded by a shield line, thus reducing the influence of external interference. Finally, the signal line, the ground line and the sensing line are covered with a single insulating coating, thus minimizing the influence of external interference.

Meanwhile, as a method of connecting the sensing line to the conductive yoke 102, there may be proposed a method of soldering the sensing line at a certain location on the yoke 102 and connecting the sensing line to the yoke 102, or a method of forming a metallic pattern at a certain location on the circuit board 107, at which the rivet 111 comes into contact with the circuit board 107 to cause the rivet 111 and the circuit board 107 to achieve electric contact, fastening the circuit board 107 through the rivet 111, electrically connecting the rivet 111 to the pattern formed on the circuit board 107, and connecting the pattern of the circuit board 107 to the sensing line through soldering.

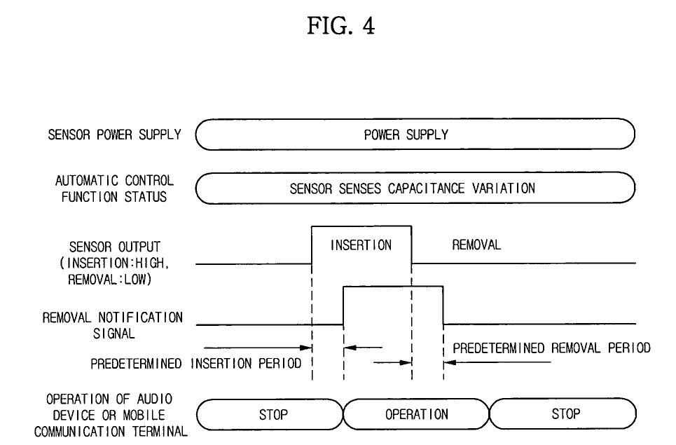

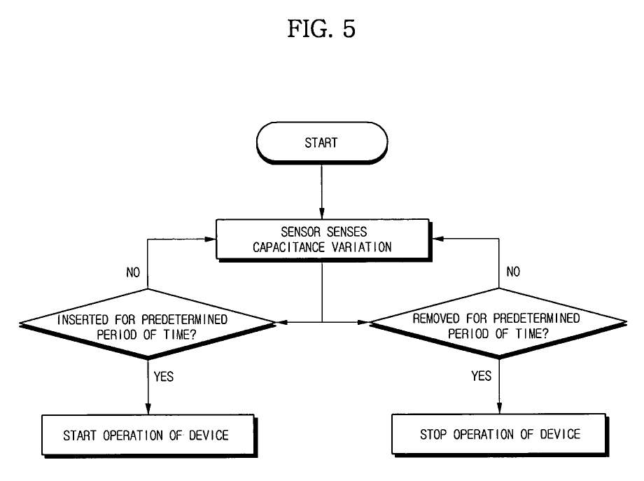

The operation of the present invention having the above construction is described with reference to FIGS. 4 and 5. If the user inserts the earphone plug 500 into the earphone jack of the audio device or the mobile communication terminal, the power of the audio device or the mobile communication terminal is supplied to the removal sensing unit 300 and the signal generation unit 400 in the earphone system through the earphone plug 500. Accordingly, the earphone system is switched over to a standby state for sensing the removal of the earpiece 100 or 100a.

Thereafter, if the user inserts the earpiece 100 or 100a into his or her ear, variation in capacitance (the “high” signal in FIG. 4) occurs in the finishing band 110 or 110a included in the earpiece 100 or 100a. The variation in capacitance is transmitted to the sensing line through the finishing band 110 or 110a, the protective grille 109, the protective cover 108, and the yoke 102, and is finally transmitted to the removal sensing unit 300 through the sensing line.

The removal sensing unit 300 counts a predetermined period of time from the time point of capacitance variation, transmitted through the sensing line, determines that the user has inserted the earpiece 100 or 100a into the ear if the variation in capacitance is maintained (that is, “high” signal) for the predetermined period of time, and controls the signal generation unit 400 so as to transmit an operation signal to the audio device or the mobile communication terminal at the point at which the predetermined period of time has elapsed. Accordingly, the signal generation unit 400 transmits a predefined operation signal to the audio device or the mobile communication terminal. The audio device or the mobile communication terminal, having received the operation signal, is switched over to a sound playback mode (in the case of the audio device) or a talk mode (in the case of the mobile communication terminal).

Thereafter, if the user removes the earpiece 100 or 100a from his/her ear, variation in capacitance (a “low” signal in FIG. 4) occurs in the finishing band 110 or 110a included in the earpiece 100 or 100a. The variation in capacitance is transmitted to the sensing line through the finishing band 110 or 110a, the protective grille 109, the protective cover 108 and the yoke 102, and is finally transmitted to the removal sensing unit 300 through the sensing line.

The removal sensing unit 300 counts a predetermined period of time from the time point of capacitance variation, transmitted through the sensing line, determines that the user has removed the earpiece 100 or 100a from his/her ear if the variation in capacitance is maintained (that is, “low” signal) for the predetermined period of time, and controls the signal generation unit 400 so as to transmit a stop signal to the audio device or mobile communication terminal at the point at which the predetermined period of time has elapsed. Accordingly, the signal generation unit 400 transmits a predefined stop signal to the audio device or the mobile communication terminal. The audio device or the mobile communication terminal, having received the stop signal, is switched over to a stop mode (in the case of the audio device) or a talk termination mode (in the case of the mobile communication terminal).

Meanwhile, as another embodiment of the present invention, an automatic control function performed by a capacitance sensor can be implemented so that it is alternatively set to a manual mode or an automatic mode. That is, a switch required to select the manual mode or the automatic mode is placed at a predetermined location on the above-described earphone system, and is electrically connected to the removal sensing unit 300.

The earphone system is constructed so that, if the user selects the manual mode, a playback function or talk function is performed only when the user presses a play button or talk button, as in the case of the typical sound playback function of the audio device or the typical talk function of the mobile communication terminal.

Further, the earphone system is preferably constructed so that, if the user selects the automatic mode, the removal sensing unit 300 senses variation in capacitance occurring in the finishing band 110 or 110a, controls the signal generation unit 400 depending on sensing results, and then controls the playback operation of the audio device or controls the talk function of the mobile communication terminal, as described above.

Accordingly, the earphone system of the present invention is advantageous in that it senses whether an earpiece has been inserted into or removed from a user's ear, and automatically controls the playback mode of an audio device connected to the earpiece or the talk mode of a mobile communication terminal connected to the earpiece, based on sensing results. Therefore, the user does not need to additionally manipulate a functional key, thus improving convenience.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An automatic control earphone system using a capacitance sensor, the earphone system including one device, selected from among an audio device and a mobile communication terminal, and at least one earpiece electrically connected to the device, comprising:
capacitance sensing means for sensing variation in capacitance generated with a human body;
a removal sensing unit for determining whether the earpiece has been inserted into or removed from the user's ear using the variation in capacitance sensed by the capacitance sensor; and
a signal generation unit for generating one selected from an operation signal and a stop signal for the device depending on sensing results of the removal sensing unit, and outputting the generated signal to the device.

2. The automatic control earphone system according to claim 1, wherein the earpiece comprises:
an earphone housing;
a voice coil excited by a sound signal transmitted from the device;
a diaphragm for vibrating depending on excitation status of the voice coil and generating sound waves;
a conductive yoke, a permanent magnet and a top plate for converting the sound signal transmitted from the device in the form of sound waves;
a circuit board for receiving the sound signal from the device;
a rivet for fastening the yoke, the permanent magnet, the top plate and the circuit board to each other;
conductive protective means for protecting the diaphragm; and
a conductive finishing band coming into contact with a human body, and made of a flexible material to prevent discomfort from occurring when the earpiece comes into contact with the human body, and
wherein a sensing line, extending from the removal sensing unit, is connected to the conductive yoke, and the conductive yoke, the conductive protective means and the conductive finishing band are installed to be in contact with each other, and wherein the removal sensing unit is electrically connected to the conductive finishing band through the conductive yoke and the conductive protective means by conductive material thereof.

3. The automatic control earphone system according to claim 2, wherein the capacitance sensor is the finishing band.

4. The automatic control earphone system according to claim 2, wherein the removal sensing unit controls the signal generation unit so that, if the variation in capacitance, sensed by the capacitance sensor, is maintained for a predetermined period of time or longer, the signal generation unit generates a predefined signal.

5. The automatic control earphone system according to claim 2, wherein the earpiece is constructed so that:
the earpiece comprises the conductive rivet for fastening the conductive yoke, the circuit board, the permanent magnet, and the top plate;
a conductive pattern is formed at a predetermined location on the circuit board to which the conductive rivet is coupled; and
the sensing line, extending from the removal sensing unit, is connected to the conductive rivet, the rivet comes into contact with the conductive yoke, and the sensing line is connected to the pattern of the circuit board, thus enabling the removal sensing unit to be electrically connected to the conductive finishing band through the conductive rivet, the conductive yoke and the conductive protective means.

6. The automatic control earphone system according to claim 2, wherein the earpiece is implemented so that an external part of the sensing line, extending from the removal sensing unit, is primarily coated with enamel so as to protect the sensing line from interference from another signal line provided in the earphone system.

7. The automatic control earphone system according to claim 6, wherein the earpiece is implemented so that the external part of the sensing line, having been primarily coated with the enamel, is secondarily surrounded by a shield line.

8. The automatic control earphone system according to claim 2, wherein the earpiece is implemented so that both the removal sensing unit and the signal generation unit are mounted on the circuit board in the earpiece.

9. The automatic control earphone system according to claim 2, wherein the earpiece is implemented so that both the removal sensing unit and the signal generation unit are separately placed at predetermined locations on a cable extending between the earpiece and an earphone plug.

10. The automatic control earphone system according to claim 2, wherein the earpiece is implemented so that both the removal sensing unit and the signal generation unit are mounted in any one selected from the audio device and the mobile communication terminal.

11. The automatic control earphone system according to claim 1, further comprising a selection switch for allowing the user to select between an automatic mode and a manual mode,
wherein the selection switch is constructed so that, if the selection switch is in the automatic mode, the earphone system senses the variation in capacitance and generates an operation signal and a stop signal for the device, whereas if the selection switch is in the manual mode, the earphone system generates the operation signal and the stop signal for the device through manipulation of the user.
